(19) United States
(12) Patent Application Publication
(10) Pub. No.: US 2010/0316475 A1
(43) Pub. Date: Dec. 16, 2010

(54) Attachment for extending the cargo carrying length of a vechicle

(76) Inventor: Harold James Ryan, St. Albans, VT (US)

Correspondence Address: THOMAS G. FERENCE, 38 THASHA LANE, # C-6, ESSEX JUNCTION, VT, 05452, US

(21) Appl. No.: 12/456,202

(22) Filed: Jun. 12, 2009

(51) Int. Cl. B60P 3/42

(52) U.S. Cl. 414/462

(57) ABSTRACT

The present invention is directed to an attachment for extending the cargo carrying length of a vehicle comprising a base frame having at least one swiveling wheel. A hitch assembly is mounted to the front end of the base frame. A bed for carrying cargo is integrated with the base frame. The bed includes a translation frame coupled with a pivot frame. The pivot frame has front and back pivot ends and a pivot axis. The pivot axis of the pivot frame is parallel to and approximately midway between the front and back pivot frame ends. The pivot frame engages the base frame along the pivot axis. A translation mechanism is connected between the pivot frame and the translation frame for translating the translation frame relative to the pivot frame. A pivot mechanism is connected between the base frame and the pivot frame for pivoting the pivot frame around the pivot axis in order to lower the back end of the translation frame to the ground.

### RELATED APPLICATIONS

This application is related to U.S. patent application (Docket No. HRYAN-CIP-01), filed Jun. 12, 2009, entitled “Trailer Apparatus Including Adjustible Wheel Assemblies”, which is incorporated herein by reference.

### FIELD OF THE INVENTION

This invention relates to an attachment apparatus for extending the cargo carrying length of a vehicle. More specifically, it is an attachment that can both extend and pivot to the ground for easy loading and unloading of cargo.

### BACKGROUND OF THE INVENTION

Since the invention of the wheel, humans have been perfecting the art of transporting cargo over land. Today, motorized vehicles such as cars, trucks and recreational vehicles have become the standard means for individuals to transport themselves and their cargo. A great way to increase the versatility of these vehicles is to add an attachment such as a trailer behind the vehicle for carrying extra cargo. A variety of trailers exist depending on the type of vehicle towing and the type of cargo to be moved. These trailers are usually designed for attachment to the vehicle only when needed.

The most common means of attaching trailers to vehicles is to use ball or pin hitches. These types of hitches provide a pivoting joint between the trailer and the back end of the vehicle. The pivoting joint allows the wheels of the trailer and the wheels of the vehicle to work independently during turns, but still follow a similar path. Except in some very specialized applications, such as the use of pintle hitches on tandem trailers during interstate travel, United States law restricts towing to no more than one articulating hitch. More than one articulated trailer in tandem has been proven to be dangerous. Therefore certain trailers already having one pivoting joint, such as tag-alongs and fifth wheels, have no practical means for further expanding their cargo carrying capacity. A user transporting their motor home attached to their truck by a fifth wheel has no way to carry alternative transportation such as a motorcycle, moped, or all terrain vehicle (ATV) that would provide more fuel efficient transportation for the user when a destination had been reached.

Another issue with most trailers is that they do not allow for easy loading/unloading of heavy cargo. During travel the trailer must have sufficient ground clearance and therefore be at some given height above the ground. Loading of cargo to that height therefore requires either lifting heavy cargo directly onto the trailer or the use of a separate ramp to move the cargo from ground level to the trailer platform. Both of these loading approaches are cumbersome.

Accordingly, there remains a continuing need for improved cargo carrying capacity on certain vehicles, especially those having tag-along trailers and fifth wheels. The current invention aims to provide a versatile way to extend the length of vehicles and allow them to carry extra equipment without the use of a second ball or pin hitch. The attachment apparatus is able to transport heavy loads, such as motorcycles, golf carts, mopeds, ATVs, etc. in a stable and secure manner behind a vehicle. The current invention also aims to provide for easy loading/unloading of heavy cargo.

### SUMMARY OF THE INVENTION

One aspect of the present invention is directed to an attachment for extending the cargo carrying length of a vehicle comprising a base frame having at least one swiveling wheel. A hitch assembly is mounted to the front end of the base frame. The hitch assembly is for rigidly connecting the base frame to the vehicle. A bed for carrying cargo is integrated with the base frame. The bed includes a translation frame coupled with a pivot frame. The pivot frame has front and back pivot ends and a pivot axis. The pivot axis of the pivot frame is parallel to and approximately midway between the front and back pivot frame ends. The pivot frame engages the base frame along the pivot axis. A translation mechanism is connected between the pivot frame and the translation frame for translating the translation frame relative to the pivot frame. A pivot mechanism is connected between the base frame and the pivot frame for pivoting the pivot frame around the pivot axis in order to lower the back end of the translation frame to the ground.

Another aspect of the present invention is directed to an attachment for extending the cargo carrying length of a vehicle comprising a base frame having at least one swiveling wheel. A hitch assembly is mounted to the front end of the base frame. The hitch assembly is for rigidly connecting the base frame to the vehicle. A bed for carrying cargo is supported on the base frame. A lifting mechanism is integrated with the bed for lifting the top surface of the bed to the cargo carrying surface of the vehicle.

### BRIEF DESCRIPTION OF DRAWINGS

The foregoing and other aspects and advantages of the invention will be apparent from the following detailed description of the invention, as illustrated in the accompanying drawings, in which:

FIG. 1 is a perspective view of the attachment apparatus of the present invention showing one embodiment of how the attachment apparatus would be used for carrying cargo behind a vehicle;

FIG. 2a is a side view of the attachment apparatus showing an embodiment where the attachment apparatus is attached to a truck;

FIG. 2b is a side view of the attachment apparatus of FIG. 2a, with the back end of the bed now being tilted to the ground to allow for easy loading of cargo;

FIG. 2c is a side view of the attachment apparatus of FIG. 2b, with the bed now being tilted flat and lifted so that the top surface of the bed is at the same level as the cargo carrying surface of the truck, i.e. the truck's bed;

FIG. 3a is a front, perspective view of the attachment of FIG. 1, separate and away from the vehicle;

FIG. 3b is a back, perspective view of the attachment of FIG. 1, separate and away from the vehicle;

FIG. 4a is a front, perspective view of the bed separate and lifted away from the attachment apparatus;

FIG. 4b is a front, perspective view showing the bed integrated with the base frame and positioned for loading and unloading cargo;

FIG. 5a is a partial cutaway, perspective view of an embodiment of the pivot assembly;

FIG. 5b is a sectional view along line 5b-5b of FIG. 5a showing an embodiment where cam followers are used to provide easy translation of the translating frame relative to the pivot frame;

FIG. 6a is a front, perspective view of the integrated frame structure of the attachment apparatus with the pivot frame and translating frames in a raised, transporting state;

FIG. 6b is a front, perspective view of the integrated frame structure of the attachment apparatus with the translating frame extended;

FIG. 6c is a front, perspective view of the integrated frame structure of the attachment apparatus with the pivot frame pivoted so as to lower the back end of the translation frame to the ground for easy loading and unloading of cargo;

FIG. 7a is a perspective view of a dual wheel assembly integrated with a first type of translating wheel assembly, the dual wheel mounted in a first position along the base frame;

FIG. 7b is a perspective view of the dual wheel assembly of FIG. 7a, the dual wheel is now mounted in a second position along the base frame;

FIG. 8 is an exploded view of the dual wheel assembly of FIGS. 7a and 7b;

FIG. 9a is a perspective view of a single wheel assembly integrated with a second type of translating wheel assembly, the single wheel located in a first position;

FIG. 9b is a perspective view of the single wheel assembly of FIG. 9a, the single wheel is now located in a second position;

FIG. 10a is a perspective view of an embodiment where the bed of the attachment apparatus has the added feature of being raised to the carrying surface of a vehicle, the bed is in the down position;

FIG. 10b is a perspective view of attachment apparatus in FIG. 10a with the bed now raised; and

FIG. 11 is a perspective view of the hitch assembly.

### DETAILED DESCRIPTION OF THE INVENTION

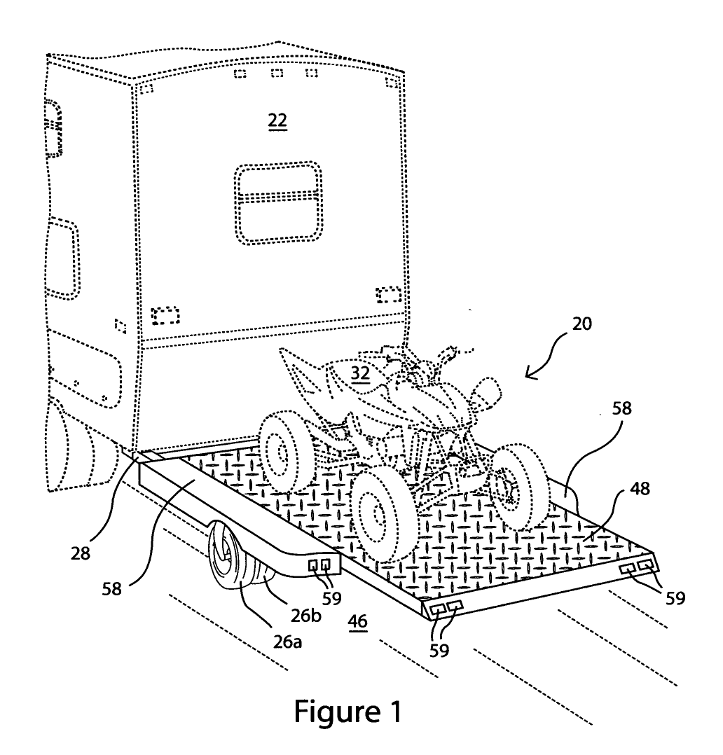

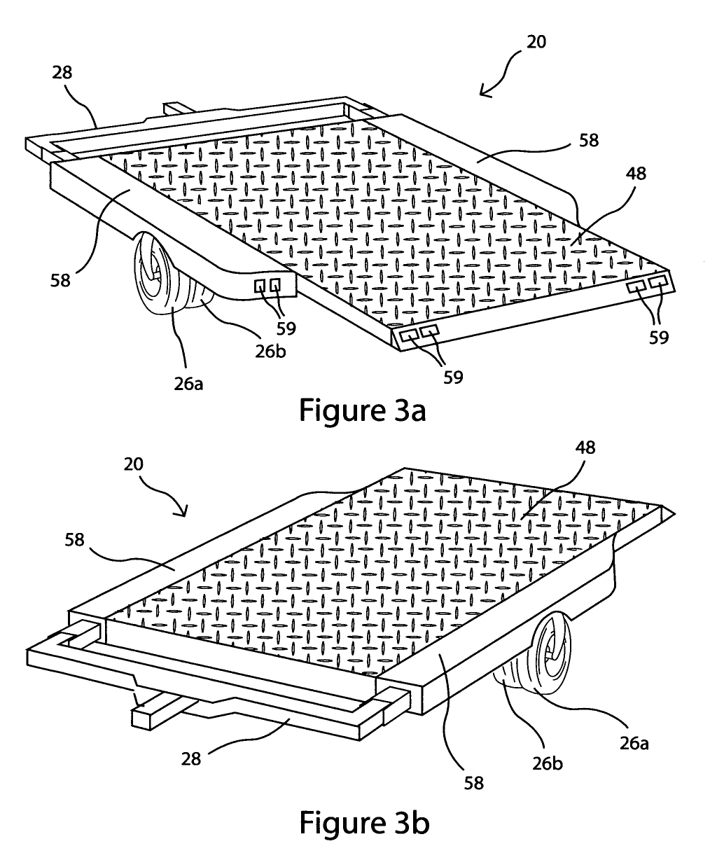

The present invention provides an improved attachment 20 for extending the cargo carrying length of a vehicle 22. FIGS. 1-11 illustrate the elements of the current invention and how they work together. Attachment 20 (a. k. a. attachment apparatus, trailer) comprises a base frame 24 having at least one wheel 26 (26a and 26b for a dual wheel). A hitch assembly 28 is mounted to the front end of base frame 24. Together wheel(s) 26 and hitch assembly 28 support base frame 24 when attached to vehicle 22. Hitch assembly 28 is preferably a rigid hitch assembly that rigidly mounts base frame 24 to vehicle 22. Hitch assembly 28 is rigid in the sense that the hitch assembly does not articulate around an axis perpendicular to the ground. Rigidly mounting hitch assembly 28 to vehicle 22 allows attachment 20 to be used with all types of vehicles, including those that already have an articulating joint such as tag-alongs and fifth wheels. With base frame 24 rigidly connected through hitch assembly 28, wheel 26 must necessarily be a swiveling wheel, a wheel that can move in all directions beneath base 22. If a non-swiveling wheel is used with a rigid hitch assembly, the resulting attachment apparatus will generate resistive forces on the vehicle when making turns. In an alternative embodiment, attachment 20 may include a non-rigid hitch assembly 28 with non-swiveling wheels, but such an attachment apparatus could not be used with vehicles 22 that already include one articulating hitch.

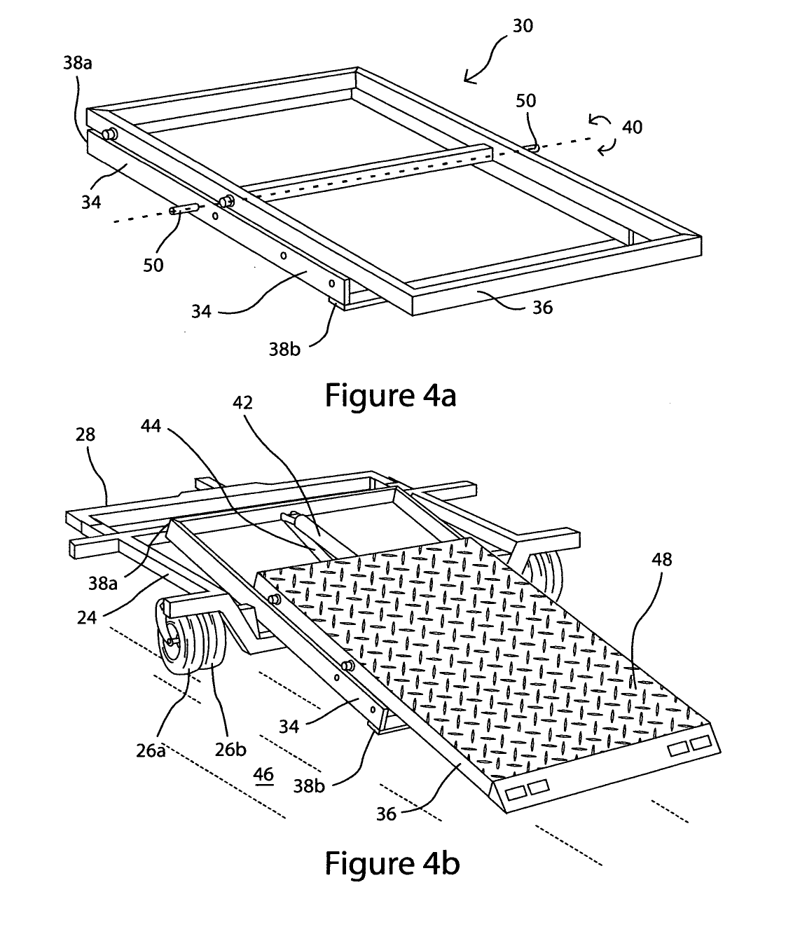

Attachment 20 further comprises a bed 30 for carrying cargo 32. Bed 30 includes a pivot frame 34 coupled with translation frame 36, FIGS. 4a and 4b. Pivot frame 34 has a front pivot frame end 38a and a back pivot frame end 38b. Pivot frame 34 also has a pivot axis 40. Pivot axis 40 is parallel to both front pivot frame end 38a and back pivot frame end 38b. Pivot axis 40 is also approximately midway between front pivot frame end 38a and back pivot frame end 38b. Pivot frame 34 engages base frame 24 along pivot axis 40. Structuring pivot axis 40 to be close to the middle of pivot frame 34 allows the pivot frame to be balanced from front to back when a heavy load is placed on top. Translation frame 36 is engaged with pivot frame 34 so as to easily translate the translation frame parallel to the pivot frame. A translation mechanism 42, which may be a hydraulic cylinder, an actuator, a cable and pulley system, etc., is connected between pivot frame 34 and translation frame 36 for translating the frames relative to each other. A pivot mechanism 44, which may be a hydraulic cylinder, an actuator, a cable and pulley system, etc., is connected between base frame 24 and pivot frame 34 for pivoting the pivot frame around pivot axis 40 in order to lower the back end of translation frame 36 to the ground 46. A plate 48 is mounted to the top of translation frame 36 for supporting cargo 32. The purpose of translation frame 36 is to extend the length of bed 30 during loading and unloading. By having the ability to translate translation frame 36 to extend outward from back pivot frame end 38b during loading and unloading and retracted during travel, the overall attachment apparatus can be made shorter for traveling. The ability to extend translation frame 36 also allows for a lower inclination angle during loading and unloading of cargo 32, which makes it easier to load and unload cargo 32. By having bed 30 include both pivot frame 34 that pivots near its midpoint and translation frame 36 that can travel parallel to extend the bed, the overall attachment apparatus 20 can be fabricated to be much smaller that other trailers. A nominal size for attachment apparatus 20 is only 8-feet by 8-feet. Although the shape of bed 30, pivot frame 34 and translation frame 36 are all preferably rectangular, other frame shapes would work as well. When frame shapes differ from a rectangle, a portion of each frame would have to have a set of parallel pivot frame bars and translation frame bars that translate parallel to each other. These bars would mimic the operation of the sides of the rectangular frames described above.

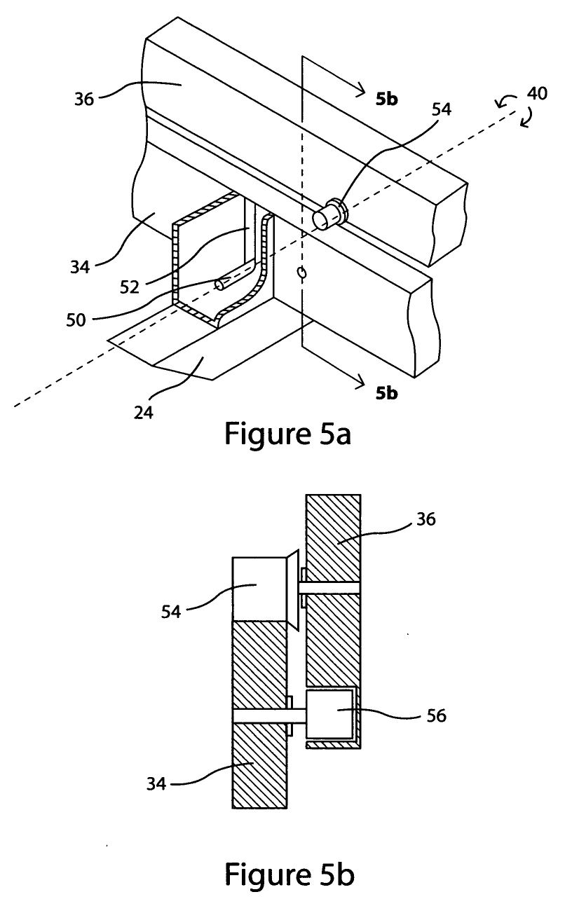

FIGS. 5a and 5b illustrate in more detail the components that enable the pivoting of bed 30 relative to base frame 24 and the translation of translation frame 36 relative to pivot frame 34. The pivot assembly is shown in FIG. 5a, here pivot frame 34 is engaged with base frame 24 along pivot axis 40. One mechanism for providing this engagement is to have a pivot pin 50 mounted on each side of pivot frame 36 along pivot axis 40. Each pivot pin 50 lies within a pivot pin slot 52 of base frame 24. Pivoting of pivot frame 34 occurs by pivoting front pivot frame end 38a and back pivot frame end 38b around pins 50. Bed 30 can be raised by moving pivot pin 50 within pivot slot 52. Bed 30 can also be removed by lifting pivot pins 50 out of pivot slot 52. Other pivoting assemblies may include a rod going along the full width of the pivot frame, pivot pins on the inside of the pivot frame, etc. FIG. 5b shows a sectional view along the line 5b-5b of FIG. 5a. In FIG. 5b, a flanged cam follower 54 is mounted to the outer side of translation frame 36 and a plain cam follower 56 is mounted to the inner side of pivot frame 34. Flanged cam follower 54 rests on the top surface of the side of pivot frame 34, while plain cam follower 56 follows a channel on the bottom of translation frame 36. Flanged cam follower 54 and plain cam follower 56 both have bearings that allow them to rotate freely when they contact a moving surface. Several pairs of cam followers, typically six per side, are mounted on pivot frame 34 and translation frame 36. This structure allows for near frictionless movement of translation frame 36 relative to pivot frame 34.

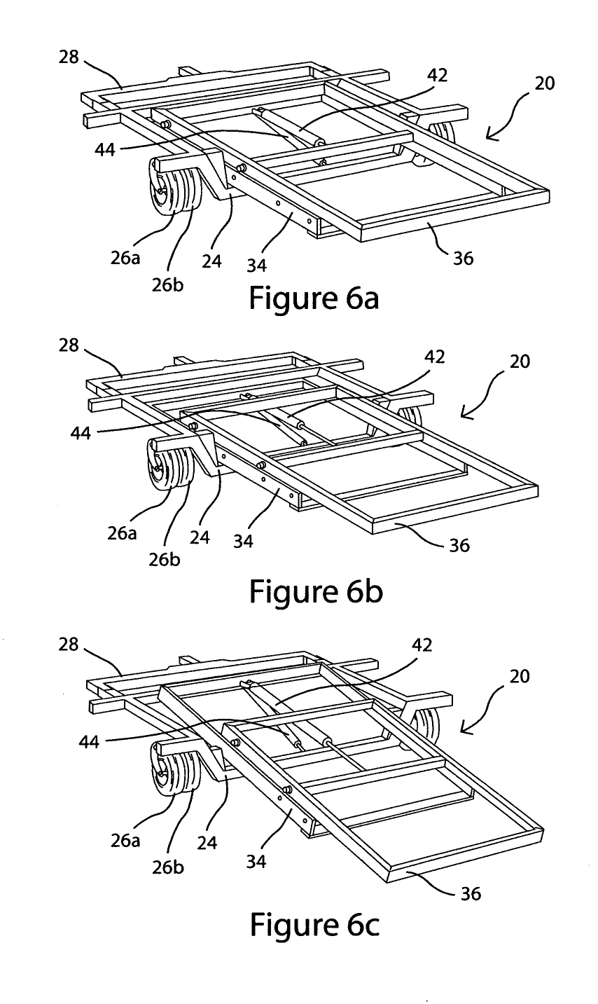

FIGS. 6a-6c illustrate operation of attachment apparatus 20 and the manner in which the components work together when loading and unloading cargo. Plate 48 and panels.58 have been removed from these figures to allow for better viewing of how the components work together. FIG. 6a shows attachment 20 with pivot frame 34 and translating frame 36 in a raised, transporting state. As the user prepares to load cargo onto attachment apparatus 20, translating mechanism 42 is activated. If a translating hydraulic cylinder is used for translation mechanism 42, the cylinder is extended between front pivot frame end 38a and the translation frame. This action translates translation frame 34 relative to pivot frame 36. Flanged cam followers 54 and plain cam followers 56 provide for near frictionless movement. Translation frame 34 is now extended as shown in FIG. 6b. Pivot mechanism 44 is then activated. If a pivoting hydraulic cylinder is used for pivot mechanism 44, the cylinder is extended between base frame 24 and front pivot frame end 38a. This action causes pivot frame 34 to tilt, and thus lower the back end of translation frame 36 to the ground, FIG. 6c. Cargo 32 would then be loaded onto plate 48 (not shown for better viewing). The process described above would then be run in reverse to move cargo in place for travel. Pivoting mechanism 44 would be activated. The pivoting hydraulic cylinder would be contracted between base frame 24 and front pivot frame end 38a This action would cause pivot frame 34 to tilt bed 30 to be level with the ground. Translation mechanism 42 would then be activated. The translating hydraulic cylinder would then be contracted between front pivot frame end 38a and translation frame 36. This action would cause translation frame 34 to pull inward and back over pivot frame 34. The cargo would now be ready for transport. It should be noted that the translation of translation frame 36 and pivot of pivot frame 34 may occur simultaneously by powering both translation mechanism 42 and pivot mechanism 44 at the same time. It should also be noted that translation mechanism 42 and pivot mechanism 44 can be activated remotely. Each mechanism may be powered from the vehicles power through a connection that runs from vehicle 22 to attachment 20 or by a self-contained power supply on the attachment.

A plate 48 is added to the top of translation frame 36 for supporting cargo. Plate 48 may have a textured surface to help prevent the cargo from sliding. Panels 58 may be provided to improve the look and aerodynamics of attachment 20. The frames (base frame 24, pivot frame 34 and translation frame 36) are typically of steel construction, but may be made from other suitable rigid, high-strength materials. Other accessories such as lights 59 (signal, brake and backup) can be integrated with attachment 20. Lights 59 connect electrically with vehicle 22 to meet required safety requirements. Attachment 20 may further include other accessories to aid with securing, protecting and carrying specific types of cargo.

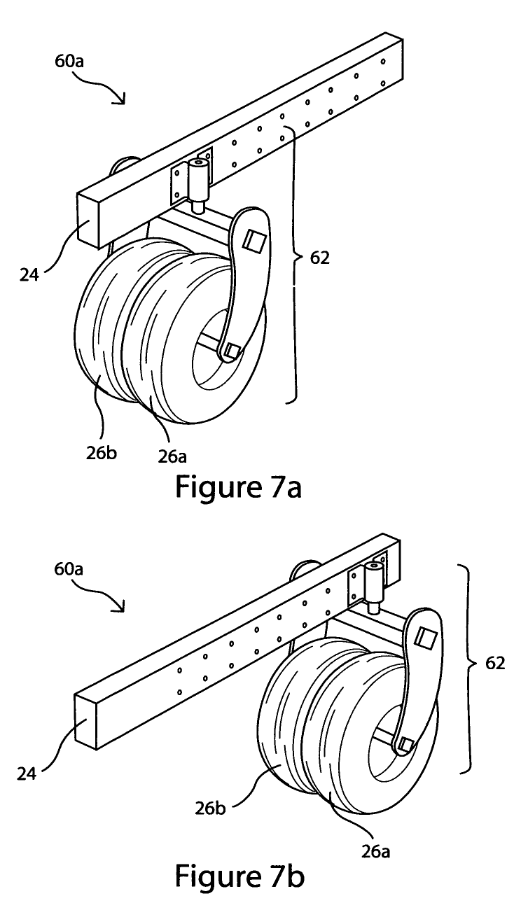

Another embodiment of the current invention is to make wheels 26 translatable along base frame 24. This may be accomplished by making wheels 26 a part of translatable wheel assemblies 60a or 60b. Translatable wheel assembly 60a is one in which wheel 26 is adjustably mounted to different positions on base frame 24 by the user. Translatable wheel assembly 60b is one in which wheel 26 is continuously movable along base frame 24 by the user. Translatable wheel assemblies 60a and 60b incorporate all of the elements shown and described in FIGS. 1-6 with the added elements shown in FIGS. 7-9. The ability to move one or more wheels 26 to different positions along base frame 24 allows the user to adjust the weight distribution of the cargo carried by attachment 20. Balancing the weight distribution of the cargo appropriately over wheels 26 allows for minimal downward force to be transmitted to vehicle 22 through hitch assembly 28 resulting in less lift on the vehicle's front end. A better balance of the weight of the cargo over wheels 26 makes for a smoother ride and improved safety. If the cargo being carried is heavier toward the back end of bed 30, the user can position wheels 26 to be closer towards that back end. If the cargo being carried is heaver toward the front end of bed 30, the user can position wheels 26 closer towards that front end. Wheels 26 can also be moved independently of each other so that one wheel is positioned more towards the front end and the other wheel is positioned more towards the back end. This can help get rid of vehicle lean by better balancing the weight of the cargo from side to side.

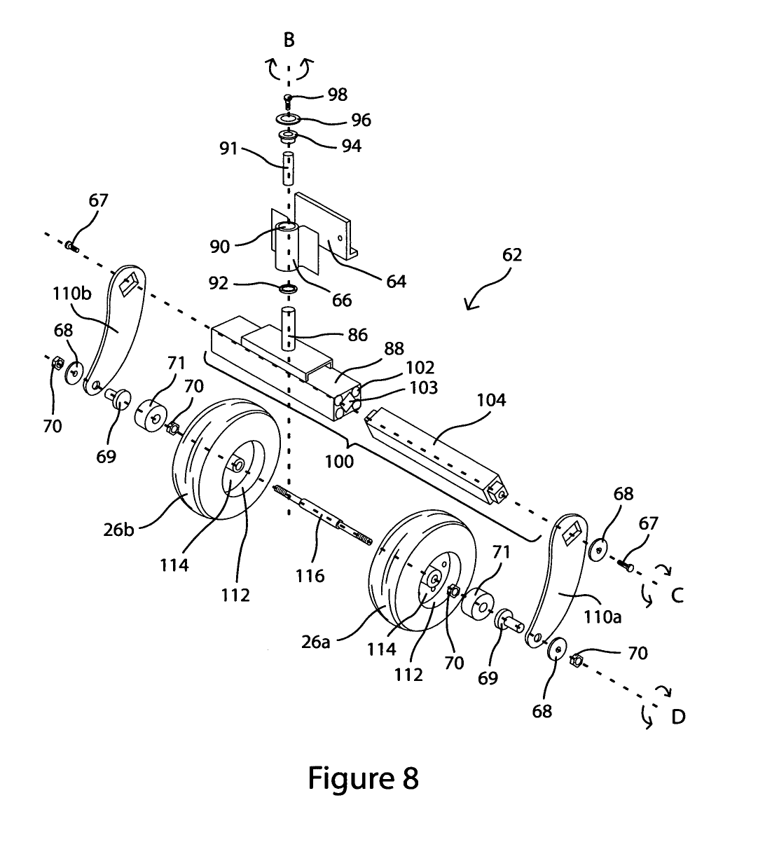

FIGS. 7 and 8 show a dual wheel assembly 62 that can be mounted manually to different positions along base frame 24. Dual wheel assembly 62 can be part of either translating wheel assembly 60a or 60b, or it could alternately be permanently mounted to base frame 24. Each dual wheel assembly includes wheels 26a and 26b. Each dual wheel assembly 62 includes a wheel mount 64 for mounting the assembly to base frame 24. A block 66 is integrated with wheel mount 64. Although block 66 is referred to as a “block”, the block may have a shape that differs from a block such as the cylinder shown. Wheels 26a and 26b, of dual wheel assembly 27, swivel around axis B. A swivel axle 86 extending at right angles to torque flex axle housing 88 is journaled from the bottom to the top of block 66 through hole 90. An oil light bearing sleeve 91 surrounds swivel axle 86, within hole 90. Bearing assembly 92, block spacer 94, thrush washer 96 and bolt 98 are all further integrated with swivel axle 86 to allow it to pivot while bearing the weight of bed 30 and any cargo 32. The swivel capability provides for wheels 26a and 26b to be able to move in all directions along the ground surface.

The damping of vibrations in dual wheel assembly 62 during travel is provided by torque flex assembly 100 that lies along and pivots with a bias around axis C. Torque flex axle assembly 100 includes elongated torque flex axle housing 88 filled with resilient material 102 that surrounds shaft 104. Resilient material 102 is preferably rubber. During fabrication resilient material 102 has a shaft hole 103, preferably of square cross-section, formed along its center axis. Shaft 104, also preferably of square cross-section, is placed within shaft hole 103. Resilient material 102 is then compressed and frozen. In the frozen state, resilient material 102 containing shaft 104 is then placed within torque flex axle housing 88 and allowed to warm. Upon warming, resilient material 102 expands to fill torque flex axle housing 88. Resilient material 102 provides for a bias that increases with the amount of pivot from a neutral position around axis C. The bias acts to damp the vibrations from wheel 26a and 26b by way of swing arms 110a and 110b that are mounted at a right angle to torque flex axle assembly 100. Torque flex axle assembly 100 is mounted at right angles to second axle 86. Shaft bolts 67 and washers 68 hold swing arms 110a and 110b to shaft 104. A swivel lock pin 106 and a swivel lock pin housing 108 combine to form a swivel lock.

Wheels 26a and 26b of dual wheel assembly 27 spin around axis D. Wheel 26a and 26b are each mounted on a rim 112 with a hub assembly 114. Hub assembly 114 includes the bearing and race along with an oil seal. A dual spindle axle 172 is journaled though the center of each hub assembly 114. Bushing 69, bushing grease cover 71, washers 68 and lock nuts 70 are used to secure dual spindle axle 116 to wheels 26a and 26b, and swing arms 110a and 110b.

Although a dual wheel assembly provides the most stability and can support the most weight, it is possible to replace wheels 26a and 26b with a single wheel 26. A single wheel assembly would incorporate all of the components of dual wheel assembly 62 with instead only one wheel and one swing arm.

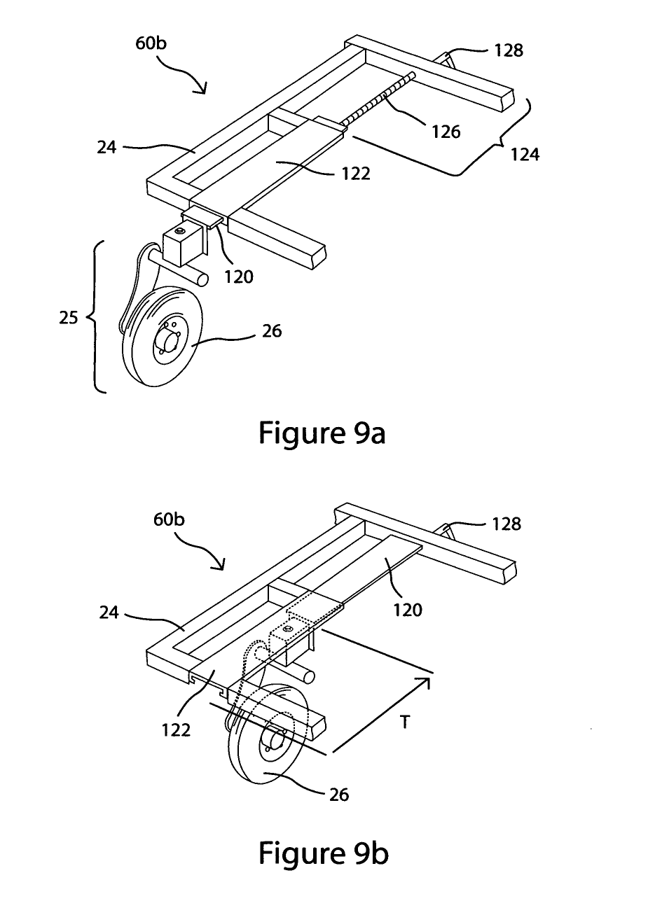

Translatable wheel assembly 60b is integrated with the attachment 20 as shown in FIGS. 9a and 9b. Here a single wheel assembly with one wheel 26 is shown. A dual wheel assembly 62 could be used as well. Translatable wheel assembly 60b comprises a first horizontal guide 120, a second horizontal guide 122 and as drive mechanism 124. First horizontal guide 120 is connected to wheel 26. Second horizontal guide 122 is mounted to base frame 24. First horizontal guide 120 and second horizontal guide 122 are coupled together so that drive mechanism 124 can move the first horizontal guide relative to the second horizontal guide. Drive mechanism 124 may include a worm gear 126 that moves first horizontal guide 120 relative to second horizontal guide 122 with each turn of the gear. Drive mechanism 124 may be actuated manually by a handle 128 or alternatively by a motor not shown. Other types of drive mechanisms may be used that incorporate hydraulic cylinders, pulley and chain systems, etc. In FIG. 9a, wheel assembly 24 is positioned all the way to the back end of base frame 24. The user may then turn handle 128, which in turn drives worm gear 126 to move first guide 120 towards the front of the vehicle. This action moves wheel 26 towards the vehicle as shown in FIG. 9b, e.g. the translation distance T.

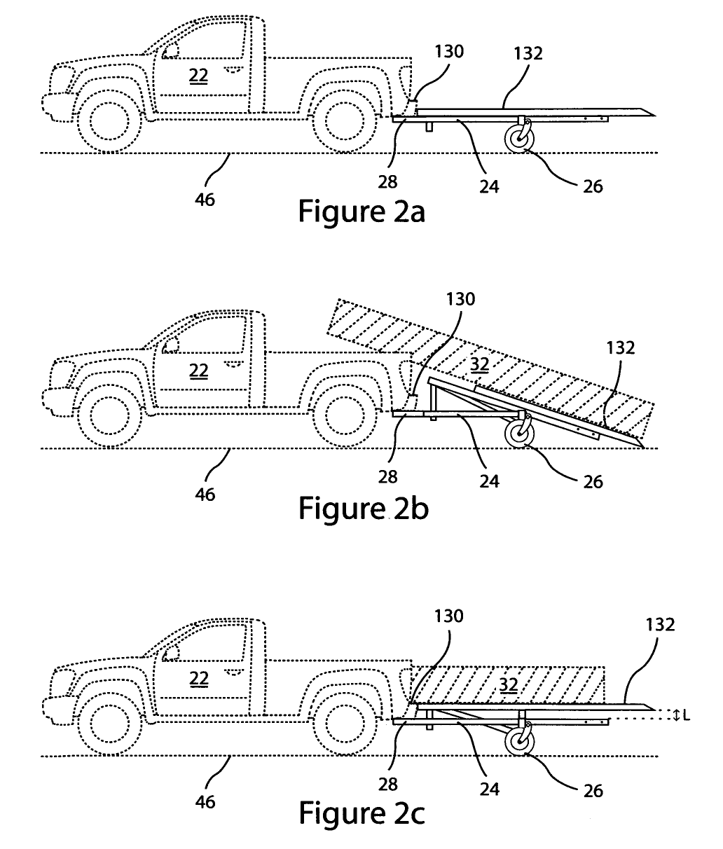

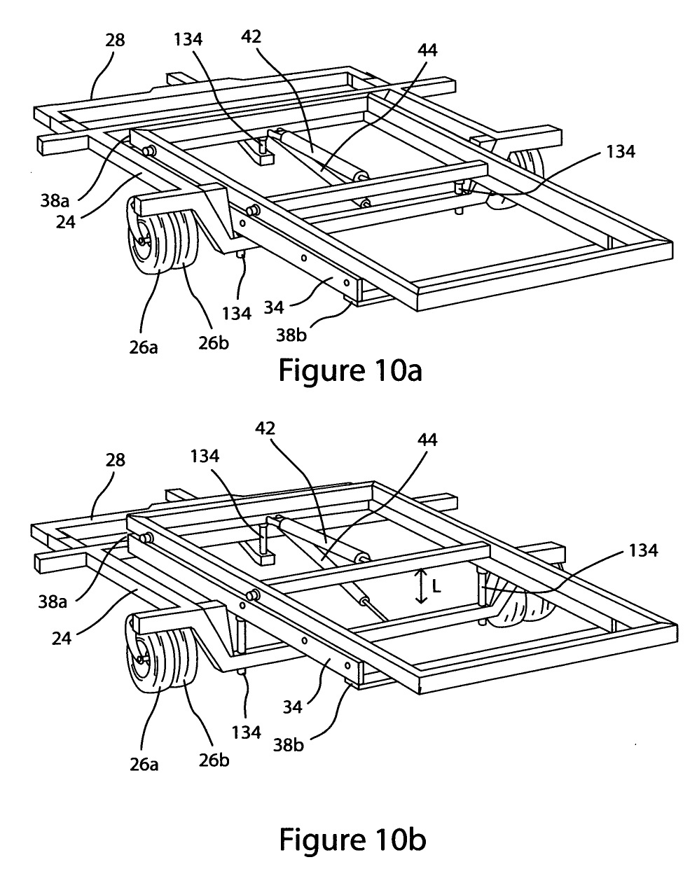

FIGS. 10a and 10b show another embodiment of the current invention where bed 30 can lift parallel to the ground. Having the ability to lift bed 30 vertically provides the user the ability to match the height of the surface of bed 30 to the same height of the carrying surface of the vehicle. FIG. 2 shows how this can be useful with a vehicle such as a truck. Carrying cargo 32 at the same level on both the truck bed 130 and the carrying surface 132 of bed 30 provides for more stable transport of the cargo. With most truck beds being at slightly different heights, the ability to adjust for height variations of different vehicles 22 allows attachment 20 to be universal between different vehicles. In this embodiment, attachment 20 comprises the components described in FIGS. 1-9 and 11, with the additional component of a lifting mechanism 134. Lifting mechanism 134 may include a plurality of lifting elements such as hydraulic cylinders that can lift bed 30 horizontally to base frame 24. FIG. 10a shows the hydraulic cylinders retracted with the bed resting on base frame 24. FIG. 10b shows the hydraulic cylinders extended with the bed lifted a distance L.

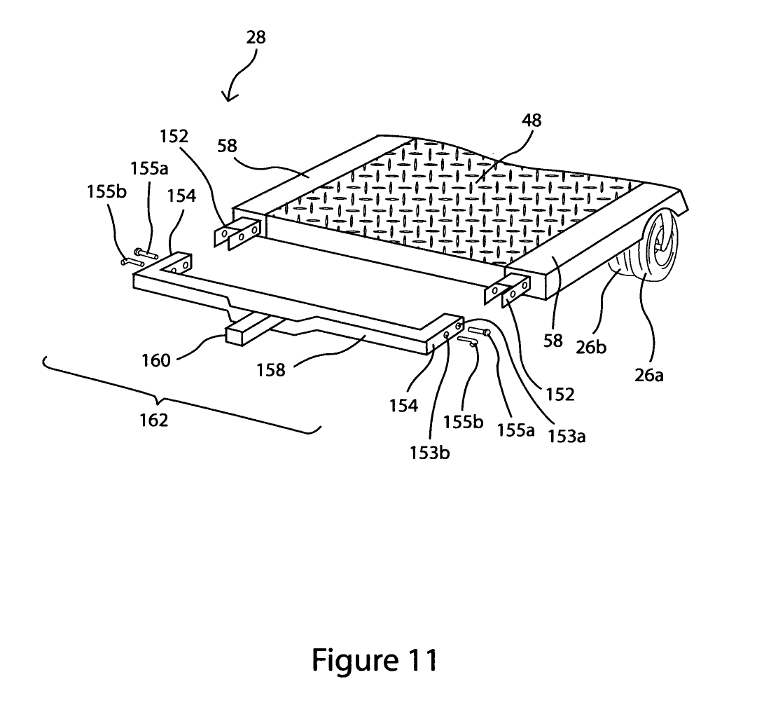

FIG. 11 illustrates the details of hitch assembly 28, which can be used with all embodiments (FIGS. 1-10). Hitch assembly 28 is preferably a rigid hitch assembly. It is rigid in the sense that it does not articulate around an axis perpendicular to the ground. Hitch assembly 28 includes dual receivers 152 mounted to the front of base frame 24. Each receiver 152 mates with a receiver coupler 154. Two through holes, first through hole 153a and second through hole 153b go through receiver 152 and receiver coupler 154 where they mate. A first mating pin 155a may be journaled through first through hole 153a keeping attachment apparatus 20 rigidly attached with no articulation from side to side, but allowing some articulation up and down when traveling. A second mating pin 155b may be journaled through second through hole 153b to keep hitch assembly from articulating up and down, thus making it rigidly attached in all directions. Total rigid attachment is important when loading and unloading cargo. Together the receiver coupler 154, hitch bar 158 and hitch 160 make up receiver hitch 162. Together the receivers 152 and receiver hitch 162 provide a rigid way to mount attachment 20 proximate the back of vehicle 22. Although a preferred structure for hitch assembly 28 is presented in FIG. 11, many other means of rigidly mounting base frame 24 to vehicle 22 exist without deviating from the scope of this invention.

Attachment apparatus 20 is designed to function with transport vehicles such as fifth wheels, tag-along trailers or other similar devices. The current invention provides a versatile way to extend the length of these vehicles. It allows for carrying extra equipment outside the vehicle without the use of an articulated hitch that might otherwise be prohibited. The attachment apparatus is able to transport heavy loads such as motorcycles, golf carts, mopeds, ATVs, etc. in a stable and secure manner behind the vehicle.

The invention is not limited to the embodiments represented and described above but includes all variants notably the shape and size of all components, the number of wheel assemblies used to support the attachment and the materials that components are manufactured from. Nothing in the above specification is intended to limit the invention more narrowly than the appended claims. The examples given are intended only to be illustrative rather than exclusive.

1) An attachment for extending the cargo carrying length of a vehicle, comprising:
a) a base frame having at least one swiveling wheel, said at least one swiveling wheel operable to swivel 360-degrees around a vertical axis;
b) a hitch assembly mounted to the front end of said base frame, said hitch assembly configured not to articulate around an axis perpendicular to the ground;
c) a bed for carrying cargo, said bed including a translation frame coupled with a pivot frame, said pivot frame having front and back pivot frame ends and a pivot axis, said pivot axis parallel to and approximately midway between said front and back pivot frame ends, said pivot frame engaging said base frame along said pivot axis;
d) a translation mechanism connected between said pivot frame and said translation frame for translating said translation frame relative to said pivot frame; and
e) a pivot mechanism connected between said base frame and said pivot frame for pivoting said pivot frame around said pivot axis in order to lower the back end of said translation frame to the ground.

2) An attachment as recited in claim 1, wherein said pivot mechanism connects between said base frame and said front pivot frame end.

3) An attachment as recited in claim 1, wherein said translation mechanism connects between said front pivot frame end and the middle of said translation frame.

4) An attachment as recited in claim 1, wherein said pivot axis lies within a plane defined by said front and back pivot frame ends.

5) An attachment as recited in claim 1, further comprising a pivot pin along said pivot axis, wherein said pivot pin engages said base frame to support said bed.

6) An attachment as recited in claim 5, further including a pivot pin slot, wherein said pivot pin pivots within said slot to raise and lower said bed.

7) An attachment as recited in claim 1, wherein said bed is liftable parallel to said base frame.

8) An attachment as recited in claim 1, further comprising a lifting mechanism for adjusting the height of said bed parallel to said base frame.

9) An attachment as recited in claim 1, further comprising a plate mounted to said translation frame.

10) An attachment as recited in claim 1, further comprising cam followers mounted between said pivot frame and said translation frame to allow said translation frame to easily translate relative to said pivot frame.

11) An attachment as recited in claim 1, wherein the position of said swiveling wheel is adjustable beneath said base frame to allow the user to balance the weight distribution of cargo supported on said bed.

12) An attachment as recited in claim 1, wherein said swiveling wheel is an element of a translatable wheel assembly connected to said base frame, said translatable wheel assembly includes a first horizontal guide connected to said swiveling wheel, a second horizontal guide mounted to said base frame and a drive mechanism for moving said first horizontal guide horizontally relative to said second horizontal guide.

13) An attachment as recited in claim 1, wherein said swiveling wheel includes two wheels on a dual wheel spindle axle.

14) An attachment as recited in claim 1, further comprising a torque flex axle assembly swivably mounted to said base frame for damping vibrations during travel.

15) An attachment as recited in claim 14, further comprising a swing arm mounted at a right angle to said torque flex axle assembly.

16) An attachment as recited in claim 15, wherein said swiveling wheel is pivotably connected at a right angle to said swing arm.

17) An attachment for extending the cargo carrying length of a vehicle, comprising:
a) a base frame having at least one swiveling wheel, said at least one swiveling wheel operable to swivel 360-degrees around a vertical axis;
b) a hitch assembly mounted to the front end of said base frame, said hitch assembly configured not to articulate around an axis perpendicular to the ground;
c) a bed for carrying cargo supported on said base frame; and
d) a lifting mechanism for lifting the top surface of said bed parallel to said base frame.

18) An attachment as recited in claim 17, wherein said bed includes a translation frame coupled with a pivot frame, said pivot frame having front and back pivot frame ends and a pivot axis, said pivot axis parallel to and approximately midway between said front and back pivot frame ends, said pivot frame engaging said base frame along said pivot axis

19) An attachment as recited in claim 17, further comprising a pivoting mechanism for pivoting said bed to the ground.
